(19) United States
(12) Patent Application Publication
(10) Pub. No.: US 2020/0311597 A1
(43) Pub. Date: Oct. 1, 2020

(54) AUTOMATIC WEIBULL RELIABILITY PREDICTION AND CLASSIFICATION

(71) Applicant: HEWLETT PACKARD ENTERPRISE DEVELOPMENT LP, Houston, TX (US)

(72) Inventors: Wilfredo E. Lugo Beauchamp, Rincon (PR); Robert McCarthy, Roseville, CA (US); Bruce N. Edson, Sacramento, CA (US)

(21) Appl. No.: 16/366,013

(22) Filed: Mar. 27, 2019

(51) Int. Cl. G06N 20/00; G06N 5/02

(52) U.S. Cl. CPC G06N 20/00; G06N 5/02

(57) ABSTRACT

A computing system and method for classifying a reliability distribution model for a part derived from empirical reliability data for the part includes a module for converting the reliability distribution model and the empirical reliability data into a plurality of data points in a matrix. The matrix is inputted to a machine-learned pattern recognition algorithm trained to assign the matrix to one of a predetermined plurality of classes. The machine-learned algorithm assigns the matrix to one of a predetermined plurality of classes according to an assessment, by the machine-learned pattern recognition algorithm, of the statistical fit between the reliability distribution model and the empirical reliability data on which the reliability distribution model was based.

### BACKGROUND

Statistical analysis such as Weibull analysis may be used to analyze reliability statistics, such as for component parts of data processing equipment such as computer equipment and the like. Such analyses may be accomplished utilizing commercial statistics packages, which can facilitate the analysis process by providing some good-of-fit statistics and data plots. Using such tools, iterative refinement of such analyses may involve manual assessment of graphical plots by an expert analyst.

### BRIEF DESCRIPTION OF THE DRAWINGS

For a detailed description of various examples, reference will now be made to the accompanying drawings, in which:

FIG. 1 is a block diagram of a reliability prediction and classification system in accordance with one or more examples of the present disclosure;

FIGS. 2A-2D are examples of reliability models generated from empirical data in accordance with one or more examples of the present disclosure;

FIGS. 3A-4D are receiver operating characteristic (ROC) plots reflecting the extent of predictive ability of a classification system in accordance with one or more examples of the present disclosure;

FIG. 4 is a block diagram of a computing resource suitable for implementation of a reliability prediction and classification system in accordance with one or more examples of the present disclosure;

FIG. 5 is a block diagram illustrating a method of reliability prediction and classification in accordance with one or more examples of the present disclosure; and

FIG. 6 is a block diagram of an implementation of a reliability prediction and classification system in accordance with one or more examples of the present disclosure.

### DETAILED DESCRIPTION

Manufacturers, such as computer equipment manufacturers, may offer a wide range of products which incorporate many tens of thousands or more of distinct types of field-replaceable parts. A manufacturer may implement systems for identifying and tracking individual components, which may number in the billions. Hence analyzing the reliability of field-replaceable components can present a significant data processing challenge.

In some approaches to reliability analysis, predictive models may be generated based on available empirical data. An assessment of the predictive models can provide an analyst with information that suggests the need for iterative refinement of the modeling process, such as by further modeling of different subsets of the empirical data. Assessment of predictive models can likewise enable an analyst to eliminate some predictive models from any further consideration.

It may be desirable to provide for the automatic assessment and classification of predictive reliability models at earlier stages of an analysis, such that certain models may be eliminated from further consideration before human intervention. Such automatic classification may increase the efficiency of reliability analysis. Automatic classification may thus improve the quality and value of reliability analysis, by reducing the amount of human intervention devoted to elimination of less useful models and focusing the inherently limited availability of human intervention on the more relevant models.

Often, manufacturers implement multi-source policies such that individual parts may be sourced on average from two, three, or more different suppliers. As used herein, the term “part” refers to any item or component, particularly field-replaceable components of computing and data processing systems and the like, for which reliability over time is of concern. Tracing each part by supplier individually can be a significant burden on reliability engineers. The burden is such that reliability analyses may only be undertaken after a strong suspicion of a serious reliability issue has arisen, such as concerns based on statistics reflecting field replacements spikes or customer escalations.

Reliability analyses may use statistical analyses such as Weibull distribution models to derive failure distribution plots enabling quality teams to predict failure rates and estimate ongoing reliability risks and future warranty costs from replacements. Accurate reliability analyses can assist in addressing reliability issues predictively rather than reactively.

Often, there is variation in reliability between suppliers or between design versions of a particular component, leading to more complicated and labor-intensive analysis of all the potentially different supplier/design version combinations. Even if the statistical analyses for possible combinations are automated, a human expert may still need to validate the prediction for each, such as by visually examining data plots and the corresponding statistics for the data to determine, for example, whether a given plot statistically “fits” the data, whether there is sufficient data to support meaningful analysis, or whether there an indication of an existing or future reliability problem. As used herein, the expression “statistical fit” and related terms, such as “goodness of fit,” or “substantiality of fit,” refers to a degree of correlation between one set of data and another, for example, the degree of correlation between empirical data and a predictive model based on that data. Statistical fit, and the “goodness” or substantiality thereof, may not be susceptible to precise definition, in that assessment of the extent or “goodness” substantiality of statistical fit may involve a degree of subjective or relative judgment, even though certain mathematical or statistical characterizations of statistical fitness may provide some guidance in such assessments.

Particularly for the purposes of identifying and predicting reliability issues, the analysis necessary is performed repeatedly and frequently. For manufacturers with large numbers of field-replaceable parts, the scope of the analytical task may be tedious if not impossible to be performed by humans. Examples are provided herein which utilize statistical modeling to generate Weibull distribution models from empirical reliability data sets and to apply a machine-learned algorithm to automatically classify reliability models based on predicted failure rates and the confidence intervals of such predictions. The application of machine learning processes to Weibull analysis advantageously allows for deeper insights to be drawn into the characteristics of numerous component subpopulations, and improves the both overall value of the analyses and the performance of computational hardware that can be utilized to perform the analyses.

In this description, for purposes of explanation, numerous specific details are set forth in order to provide a thorough understanding of the examples disclosed herein. It will be apparent, however, to one skilled in the art that the disclosed example implementations may be practiced without these specific details. In other instances, structure and devices are shown in block diagram form in order to avoid obscuring the disclosed examples. Moreover, the language used in this disclosure has been principally selected for readability and instructional purposes and may not have been selected to delineate or circumscribe the inventive subject matter, resorting to the claims being necessary to determine such inventive subject matter. Reference in the specification to “one example” or to “an example” means that a particular feature, structure, or characteristic described in connection with the examples is included in at least one implementation.

The terms “computing system” and “computing resource” are intended broadly to refer to at least one electronic computing device that includes, but is not limited to including, a single computer, virtual machine, virtual container, host, server, laptop, and/or mobile device, or to a plurality of electronic computing devices working together to perform the function(s) described as being performed on or by the computing system or computing resource. The terms also may be used to refer to a number of such electronic computing devices in electronic communication with one another, such as via a computer network.

The term “computer processor” is intended broadly to refer to one or more electronic components typically found in computing systems, such as microprocessors, microcontrollers, application-specific integrated circuits (ASICS), specifically-configured integrated circuits, and the like, which may include and/or cooperate with one or more memory resources, to perform functions through execution of sequences of programming instructions.

The terms “memory” and “memory resources” are intended broadly to refer to devices providing for storage and retrieval of data and programming instructions, including, without limitation: one or more integrated circuit (IC) memory devices, particularly semiconductor memory devices; modules consisting of one or more discrete memory devices; and mass storage devices such as magnetic, optical, and solid-state “hard drives.” Semiconductor memory devices fall into a variety of classes, including, without limitation: read-only-memory (ROM); random access memory (RAM), which includes many sub-classes such as static RAM (SRAM), dynamic RAM (DRAM), non-volatile RAM (NVRAM), and others; electrically-alterable memory; flash memory; electrically-erasable programmable read-only memory (EEPROM), and others.

The term “non-transitory storage medium” is intended broadly to include any and all of the above-described forms of memory resources, and one or more such resources, comprising physical, tangible storage media that store the contents described as being stored thereon.

The term “cloud,” as in “cloud computing” or “cloud resource,” refers to a paradigm that enables ubiquitous access to shared pools of configurable computing resources and higher-level services that can be rapidly provisioned with minimal management effort; often, cloud resources are accessed via the Internet. An advantage of cloud computing and cloud resources is that a group of networked computing resources providing services need not be individually addressed or managed by users; instead, an entire provider-managed combination or suite of hardware and software can be thought of as an amorphous “cloud.”

The terms “application,” “function,” and “module” refer to one or more computing, programs, processes, workloads, threads and/or sets of computing instructions executed by a computing system, and to the computing hardware upon which such instructions may be performed. Example implementations of applications, functions, and modules include software modules, software objects, software instances and/or other types of executable code. The use of the term “application instance” when used in the context of cloud computing is intended to refer to an instance within the cloud infrastructure for executing applications (e.g., for a resource user in that user's isolated instance).

Any application, function, module described herein may be implemented in various hardware arrangements and configurations to embody the operational behavior of the application, function, or module described. As a non-limiting example, an application, function, or module may be implemented in hardware including a microprocessor, microcontroller, or the like, incorporating or cooperating with program storage hardware embodying instructions to control the hardware to operate as described. As another non-limiting example, an application, function, or module may be implemented in hardware including application-specific integrated circuitry (ASIC) tangibly embodying the function of such application, function, or module as described.

The term “machine learning” refers to algorithms and statistical models, that computers and computing systems use to perform specific tasks without using explicit instructions, instead relying on models, inference and other techniques. Machine learning is considered a subset of the broader field of artificial intelligence. “Machine-learned algorithms” are algorithms which generally involve accepting and processing input data according to a desired function and/or to generate desired output data. The desired function of a machine-learned algorithm, typically implemented by a computer processor, is established by a using one or more sample datasets, known as “training data,” to effectively “program” the processor to perform the desired function. Thus, machine-learned algorithms enable a processor to perform tasks without having explicit programming to perform such tasks.

For example, if a desired task is to recognize the presence of a particular data pattern within a given data object, the training data for a machine learning algorithm may include data objects known to be with and without the pattern to be recognized. Once trained, a system including a processor implementing the machine-learned algorithm takes an unknown dataset as input, and generates an output or performs some desired function according to its training. In the foregoing pattern recognition example, application of the machine-learned algorithm on a data object (the input to the algorithm) may cause the data object to be classified according to whether or not the pattern was recognized in the data object. In this example, classification of the input data object according to the training of the algorithm constitutes the desired output of the machine-learned algorithm.

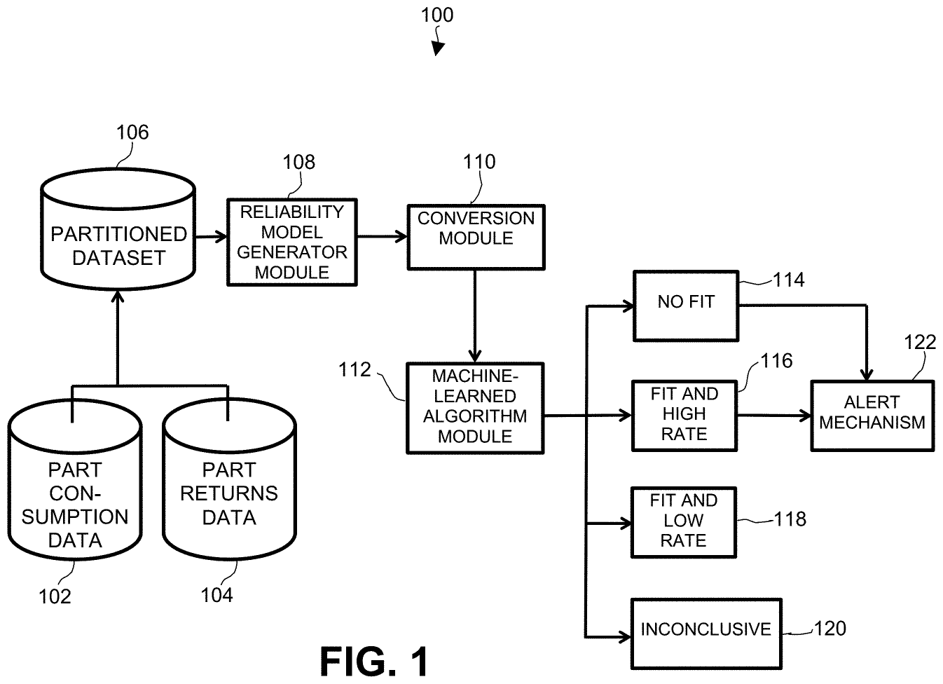

Referring to FIG. 1, there is shown a block diagram of a reliability prediction and classification system 100 in accordance with one example. In this example, system 100 utilizes input in the form of part consumption data 102 and part returns data 104. Part consumption data 102 and part returns data 104 constitute the empirical data input to system 100 and reflect statistics regularly compiled and maintained by manufacturers in the normal course of business for the purposes of reliability and quality control analysis. Such statistics may include, for example, the manufacturer of a part, its manufacturing date, and so on. In this example, part consumption data 102 and part returns data 104 may be transformed into a partitioned dataset 106, wherein different data partitions represent, for example, distinct parts from distinct vendors, sub-grouped by other criteria, such as product, product manufacture or shipment date (i.e., “vintage”), or other factors that may be regarded by reliability analysts to be of interest or importance to the analytical process.

In one example, partitioned dataset 106 may be created through use of a distributed processing database. The distributed processing database allows for the distributed processing of large data sets across clusters of computers using simple programming models. The distributed processing database can scale up from single servers to thousands of machines, each offering local computation and storage, making the framework suitable for the purposes of this example, where very large amounts of raw data, such as part consumption data 102 and part returns data 104, may be involved.

A reliability model generator module 108 in system 100 operates on partitions of data in partitioned dataset 106 to perform a statistical data fit operation on data partitions, in order to generate reliability models from data partitions. In this example, a Weibull distribution analysis is performed on a partition to generate a statistical model applying a Weibull two-parameter distribution approach to estimate the probability density function (PDF) over a desired confidence interval using the time-to-failure data for each part based on unit shipment date. In one example, reliability model generator module 108 utilizes the R programming language and software environment to generate the statistical models. The R language and environment is widely used among statisticians and data analysts for data modeling, particularly when, as in this example, potentially large quantities of data and large numbers of data partitions in partitioned dataset 106 may be involved and scalability is desirable.

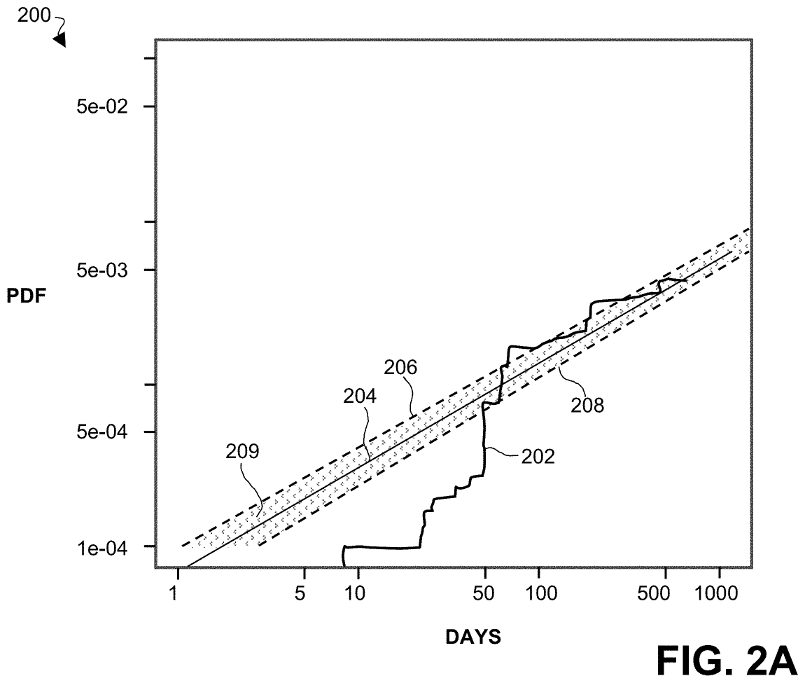

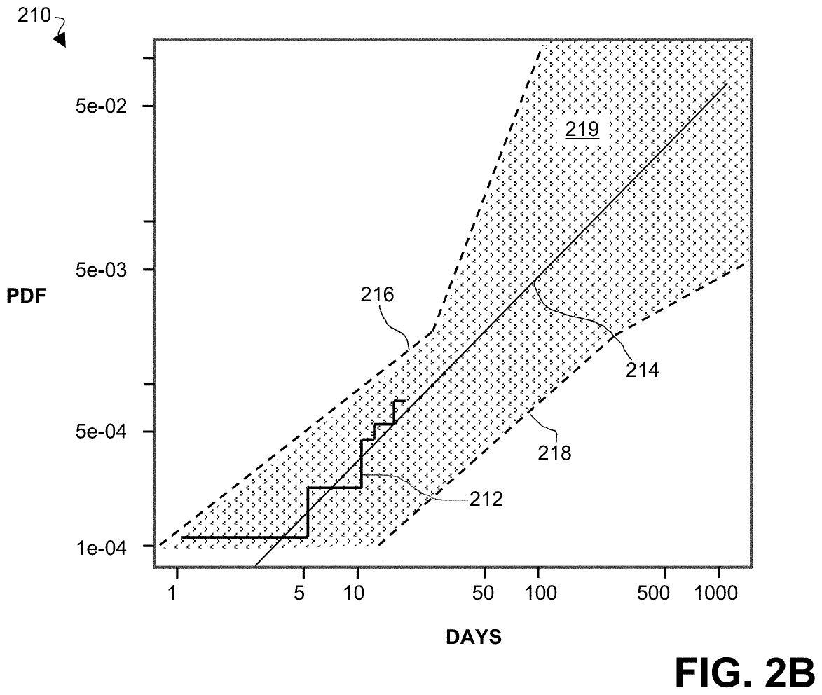

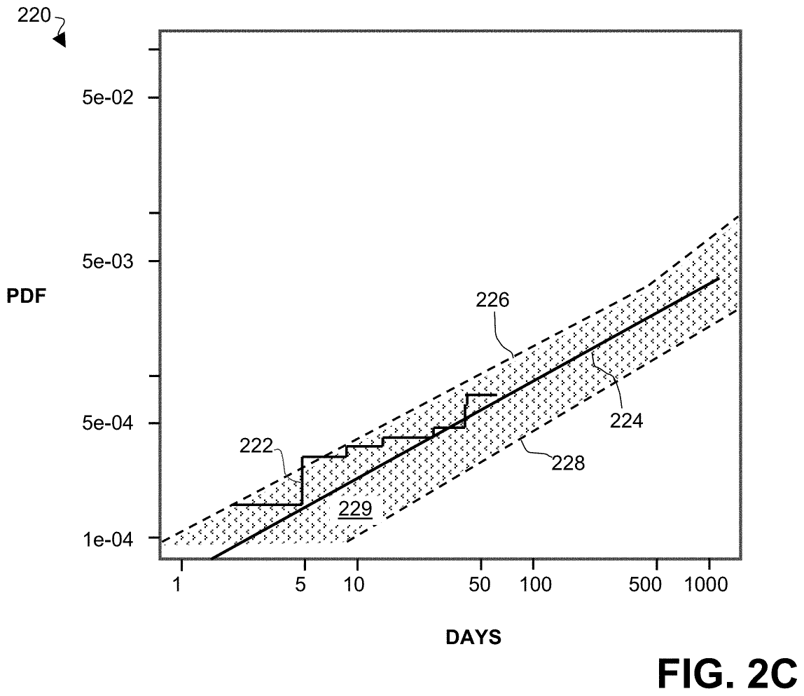

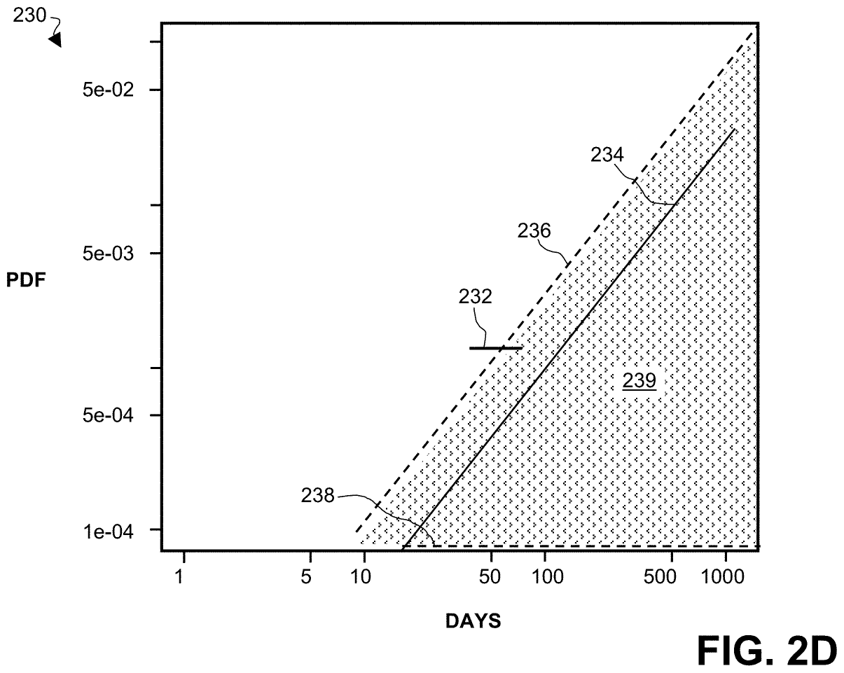

FIGS. 2A-2D are example graphical plots of probability models 200, 210, 220, and 230, respectively, generated using Weibull analysis according to this example. In each of FIGS. 2A-2D, the respective models 200, 210, 220, and 230 are shown along with a plot of underlying empirical data. In each case, the reliability models include three elements: (1) a median confidence function, which is derived to represent a “good fit” or “best fit” to the empirical data; (2) an upper confidence function, which represents an upper limit of the prediction model; and (3) a lower confidence function, which represents a lower limit of the prediction model. The empirical data is the data produced from actual time-to-failure information. In each of the plots of FIGS. 2A-2D, the horizontal axis represents confidence interval time (in days), and the vertical axis represents the probability density function (PDF) of the model.

In FIG. 2A, the empirical data from which model 200 is derived is identified with reference numeral 202, the median confidence function is identified with reference numeral 204, the upper confidence function is identified with reference numeral 206, and the lower confidence function is identified with reference numeral 208. Shaded region 209 in FIG. 2A reflects the confidence interval for model 200.

In FIG. 2B, the empirical data from which model 210 is derived is identified with reference numeral 212, the median confidence function is identified with reference numeral 214, the upper confidence function is identified with reference numeral 216, and the lower confidence function is identified with reference numeral 218. Shaded region 219 in FIG. 2B reflects the confidence interval for model 210.

In FIG. 2C, the empirical data from which model 220 is derived is identified with reference numeral 222, the median confidence function is identified with reference numeral 224, the upper confidence function is identified with reference numeral 226, and the lower confidence function is identified with reference numeral 228. Shaded region 229 in FIG. 2C reflects the confidence interval for model 220.

In FIG. 2D, the empirical data from which model 230 is derived is identified with reference numeral 232, the median confidence function is identified with reference numeral 234, the upper confidence function is identified with reference numeral 236, and the lower confidence function is identified with reference numeral 238. Shaded region 239 in FIG. 2D reflects the confidence interval for model 230.

Each of the reliability models of FIGS. 2A-2D reflects a different relationship between the respective empirical data and prediction models. In particular, FIG. 2A represents a “no-fit” case, where the prediction model 200, including functions 204, 206, and 208, reflects a substantial lack of correlation or “fit” with the empirical data 202. FIG. 2B, on the other hand, represents a “fit-and-high-rate” case, where the prediction model 210, including functions 214, 216, and 218, reflects a substantial correlation or “fit” with the empirical data 212, and where the predicted failure rate, as reflected generally by the relatively steeper slopes of functions 214, 216, and 218, particularly upper confidence function 216, and the plot 212 of empirical data is relatively high. FIG. 2C represents a “fit and low rate” case, where the prediction model 220, including functions 224, 226, and 228, reflects a substantial correlation or “fit” with empirical data 222, but where the predicted failure rate, as reflected generally by the relatively less-steep slopes of functions 224, 226, and 228, is relatively low. Finally, FIG. 2D represents an “inconclusive” case, where there is not enough empirical data 232 to make an assessment of correlation with a prediction model 230 including functions 234, 236, and 238.

A Weibull distribution model which may be considered to have a favorable goodness-of-fit metric may nevertheless provide a poor explanation of underlying empirical data if it misses important differences in the sub-populations or errors in the data, such as mistaken assumptions about when a unit started life. A reliability engineer may be required to visually and subjectively determine whether a given model is sufficient and/or if there are any unusual features which the model does not explain, indicating the need for further investigation, and potentially the first sign of a new failure mode.

With continued reference to FIG. 1, once a reliability model is generated by reliability model generator module 108, the model and underlying empirical data are then converted into an input matrix format for which a machine-learned algorithm has been trained. This conversion is represented by conversion module 110 in FIG. 1.

In one example, each function of a model and its underlying empirical data is converted into the desired input matrix format as follows:

Empirical input data may already be in a Cumulative Distribution Probability format, or can be converted to such a format, such that conversion module 110 may convert the empirical data to a set of a predetermined number of data points, for example, 100 data points, where the probability on the empirical data is between 0.01 and 0.99 divided evenly. Conversion module 110 may change these values to improve accuracy on certain models.

For each median confidence function of a reliability prediction model, which is a function representing a “best fit” to the empirical data attainable by reliability model generator module 108, the specific probability range to be used may be unknown without prior knowledge of the function. For that reason, in one example conversion module 110 evaluates the median confidence function in a two-pass approach, where first the function is evaluated in a first probability range, for example, [0.0001 to 0.1], to generate a larger number of data points for example, 10,000 points. For reliability analyses, the basic behavior of median confidence function is to receive a failure probability as input and to output a number of days for a component to reach that failure probability. The period of interest for any given analysis may differ. In one example, a period of interest corresponding to a warranty period for an item may be desired. Thus, on a second pass, conversion module 110 trims the evaluation to yield only the valid probabilities within the period of interest. Based on this valid range the function is then evaluated again to derive a predetermined number of data points, for example, 100 data points.

For each of the upper and lower confidence functions, conversion module 110 may employ the same approach as used with the median confidence function, namely a two-pass approach resulting in derivation of a predetermined number of data points, for example, 100 data points, for each of the upper and lower confidence functions.

Conversion module 110 thus produces an input matrix consisting of the collections of data points for the empirical data, the median confidence function, and the upper and lower confidence functions. For example, a resulting input matrix derived by conversion module 110 may consist of a total of 400 data points for a given model, with 100 points from the empirical data, 100 points from the evaluation of the empirical function evaluated from a probability of [0.0001] to a probability P_{M} at or near the endpoint of the interval of interest, 100 points from the upper confidence function evaluated from a probability of [0.0001] to a probability P_{UCI} at or near the endpoint of the interval of interest, and 100 points from the upper confidence function evaluated from a probability of [0.0001] to a probability P_{LCI} at or near the interval of interest.

It is to be noted that P_{M}≠P_{UCI}≠P_{LCI} since the behaviors of the median confidence function and the upper and lower confidence functions are different, and each has its own probability range. To this list an N input parameter may be added, where N represents the number of empirical data values available. The addition of this parameter may increase the overall machine learning algorithm accuracy, since it may facilitate finding patterns in datasets normally deemed to have an insufficient number of data points.

Referring to FIG. 1, once an input matrix is created by conversion module 110, the input matrix is applied as an input to a machine-learned algorithm module 112 which as described herein is trained to process input matrices as described herein. In particular, in this example, machine-learned algorithm module is trained to classify an input matrix into one of a plurality of classes, as follows:

A “no fit” class, represented by block 114 in FIG. 1, corresponds to a reliability model generated by reliability model generator module 108 that exhibits a relatively low degree of fit or correlation to underlying empirical data. The minimum degree of fit is determined by the training of machine-learned algorithm module 112.

A “fit and high rate” class of an input matrix, represented by block 116 in FIG. 1, corresponds to a reliability model generated by reliability model generator module 108 that exhibits at least a minimum degree of fit to underlying empirical data, and which exhibits a relatively high maximum predicted failure rate during the interval of interest, the relative degree of the maximum failure rate again being determined by the training of machine-learned algorithm module 112.

A “fit and low rate” class of an input data matrix, represented by block 118 in FIG. 1, corresponds to a reliability model generated by reliability model generator module 108 that exhibits a least a minimum degree of fit to underlying empirical data, and which exhibits a relatively low maximum predicted failure rate during the interval of interest, the relative degree of the maximum failure rate again being determined by the training of machine-learned algorithm module 112.

Finally, in this example, an “inconclusive” class of an input data matrix, represented by block 120 in FIG. 1, corresponds to a reliability model generated by reliability model generator module 108 that reflects an insufficient quantity of empirical data, such that no fit of the empirical data to a model is possible according to the training of machine-learned algorithm module 112.

Depending upon the class to which a given input matrix is assigned by machine-learned algorithm module 112, different actions may be taken. In the example of FIG. 1, both the no fit class 114 and the fit and high rate class 116 are shown coupled to an alert mechanism block 122, which may be implemented to provide a notification to a user of instances where a prediction model generated reliability model generator module 108 either exhibits an insufficient fit to the empirical data (block 114), or where the prediction model indicates a good fit of the empirical data to a model that shows a relatively high failure rate. Such an alert may indicate to a user that further reliability analysis is appropriate. It is to be noted that when a matrix is assigned to certain classifications, in this example fit and low rate classification 118 and inconclusive classification 120, alert mechanism is not utilized, effectively reducing the number of data modules which must be considered by a human expert.

Different machine learning algorithms may be utilized in the implementation of machine-learned algorithm module 112, including, for example, logistic regression algorithms, functions from the open-source XGBoost software library, k-nearest neighborhood (k-NN) algorithms, artificial neural networks, and decision trees, and random decision forest (random forest) algorithms. In one example, a random forest algorithm provides desirable results, as reflected particularly in its Receiver Operating Characteristic, Multi-class Area Under the Curve (“ROC-MAUC”) metrics. The following Table 1 lists the values of all the metrics from a random forest algorithm in accordance with one example.

TABLE 1
Random Forest Algorithm Metrics

| Metric | Metric Description | Value |
|---|---|---|
| Accuracy | Proportion of correctly-classified observations | 0.759 |
| Precision | Unweighted average of precision for all classes | 0.7321 |
| | (Proportion of predicted X that were indeed X) | |
| Recall | Unweighted average of recall for all classes | 0.7804 |
| | (Proportion of actual class X found by the | |
| | classifier) | |
| F1 Score | Harmonic mean between Precision and Recall | 0.7481 |
| Hamming | Fraction of labels that are incorrectly predicted | 0.241 |
| loss | (the lower the better) | |
| Log loss | Error metric that takes into account the predicted | 0.6883 |
| | probabilities (the lower the better) | |
| ROC - | Area under the ROC; from 0.5 (random model) to | 0.924 |
| MAUC | 1 (perfect model) | |
| Score | | |

In one example, machine-learned algorithm module 112 is trained using a grid search on multiple combinations of algorithm parameters. In one example, twelve combinations of the following three parameters may be used: (1) minimum sample split, which is the minimum number of samples required to split an internal node; (2) maximum depth, which is used to limit overtraining; and (3) minimum samples leaf, which is the minimum number of samples required to be at a leaf node. A combination yielding a ROC-MAUC score of at least a predetermined minimum value may then be selected for the algorithm. In one example, a minimum sample split of 30, a maximum depth of 5 and a minimum samples leaf of 10 yields an ROC-MAUC score of 0.905240059, as shown in the following Table 2:

TABLE 2
Grid Search Optimization Results

| Minimum | Maximum | Minimum | |
|---|---|---|---|
| Sample Split | Depth | Samples Leaf | Score |
| 3 | 5 | 1 | 0.903778665 |
| 3 | 10 | 1 | 0.903547581 |
| 3 | 15 | 1 | 0.903203948 |
| 3 | 20 | 1 | 0.903028496 |
| 30 | 5 | 10 | 0.905240059 |
| 30 | 10 | 10 | 0.90445871 |
| 30 | 15 | 10 | 0.904225729 |
| 30 | 20 | 10 | 0.904225729 |
| 300 | 5 | 100 | 0.80724419 |
| 300 | 10 | 100 | 0.80724419 |
| 300 | 15 | 100 | 0.80724419 |
| 300 | 20 | 100 | 0.80724419 |

In one example, machine learned algorithm module 112 uses 100 numerical decisions trees and creates a bootstrapped dataset (which allows repetition) with random numbers of features at each stage for each tree. After the bootstrapped dataset is created for each tree the Gini index is used as the split quality criteria. (A Gini index is a measure of statistical dispersion intended to represent the distribution of data within a data set). For algorithm validation a new record which is not part of the training data is passed against all built trees and an aggregate decision is made from the ensemble results of all the trees (normally called a “bagging” process).

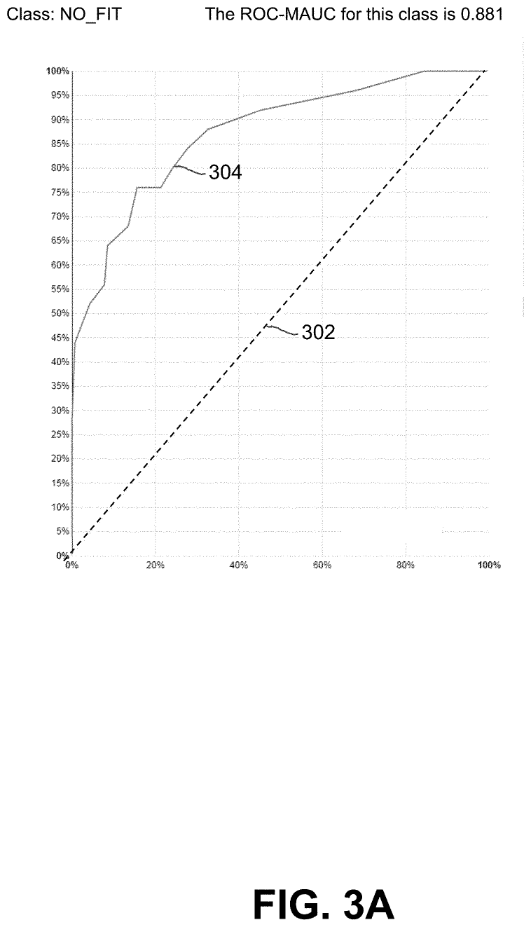

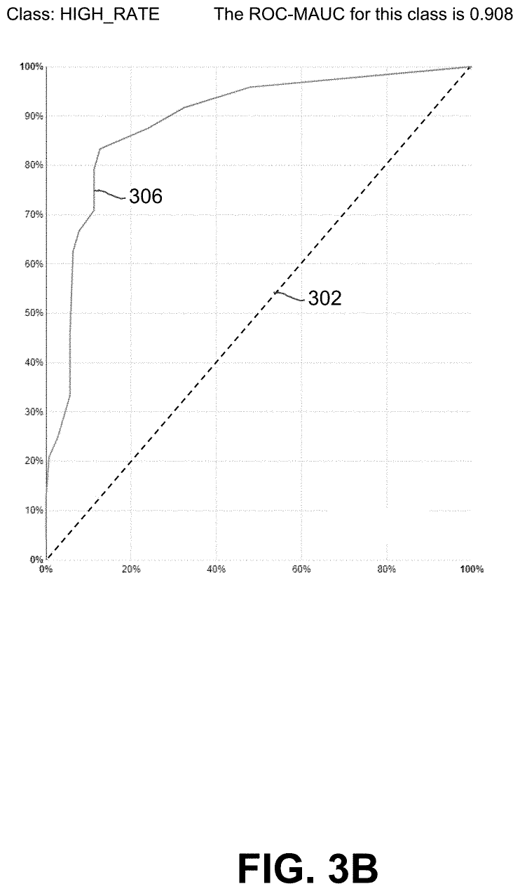

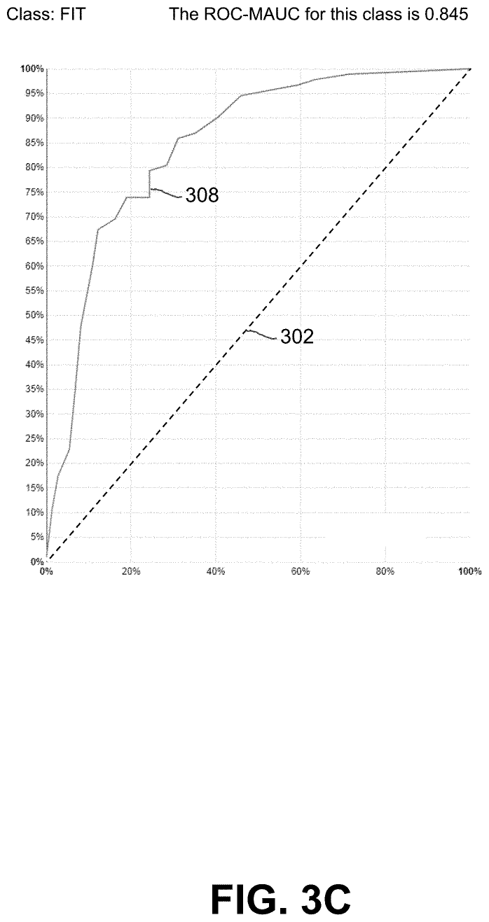

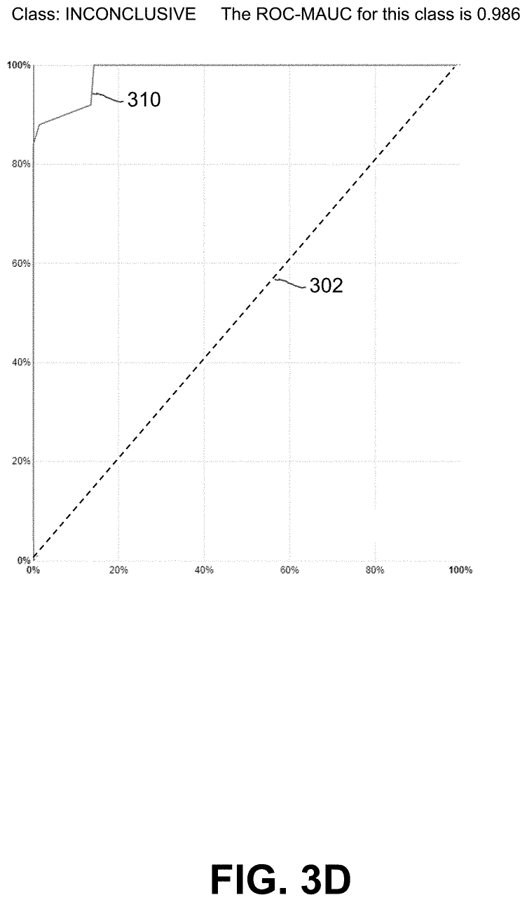

FIGS. 3A-3D show the different ROC-MAUC behavior for the different classes in accordance with one example. In each of FIGS. 3A-3D, a line 302 represents a line of no-discrimination. Points above line 302 in FIGS. 3A-3D represent good predictive results for a model, while points below line 302 represent bad predictive results. Thus, the best possible predictive model would yield a point at the upper left corner of ROC-MUAC plots such as those in FIG. 2A-2D, reflecting the highest true positive prediction rate (TPR) and the highest true negative prediction rate (TNR), and the lowest false positive prediction rate (FRP) and false negative prediction rate (FNR). Points along the line of no-discrimination, such as lines 302 in FIGS. 3A-3D represent the predictive behavior of a random guess, e.g., flipping a coin).

FIG. 3A is a ROC-MUAC plot of a model exhibiting “no fit” to the underlying empirical data, such as the model and data described above with reference to FIG. 2A. A line 304 in FIG. 3A represents the maximum statistical probability of accurate prediction of the underlying model. In this example, the ROC-MUAC score is 0.881.

FIG. 3B is a ROC-MUAC plot of a model exhibiting “fit and high rate” of predictive behavior a model relative to the underlying empirical data, such as the model and data described above with reference to FIG. 2B. A line 306 in FIG. 3B represents the maximum statistical probability of accurate prediction of the underlying model. In this example, the ROC-MUAC score is 0.908.

FIG. 3C is a ROC-MUAC plot of a model exhibiting “fit and low rate” predictive behavior relative to the underlying empirical data, such as the model and data described above with reference to FIG. 2C. A line 308 in FIG. 3C represents the maximum statistical probability of accurate prediction of the underlying model. In this example, the ROC-MUAC score is 0.845.

FIG. 3D is a ROC-MUAC plot of a model exhibiting “inconclusive” predictive behavior of a model relative to the underlying empirical data, such as the model and data described above with reference to FIG. 2D. A line 310 in FIG. 3D represents the maximum statistical probability of accurate prediction of the underlying model. In this example, the ROC-MUAC score is 0.986.

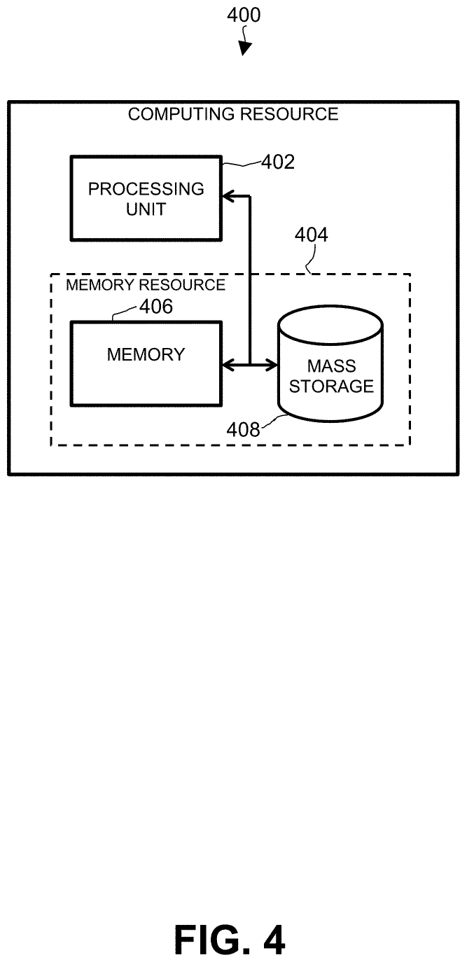

FIG. 4 is a block diagram of a computing resource 400 for performing reliability analysis in accordance with examples set forth herein. In particular, one or more computing resources such as computing resource 400 in FIG. 4 may be utilized to implement the functional components of system 100 from FIG. 1, including one or more of the reliability model generator module 108, conversion module 110, and machine-learned algorithm module 112 in FIG. 1.

As shown in FIG. 4, computing resource 400 may comprise a processing unit 402, operatively coupled to a memory resource 404. Memory resource 404 may comprise memory 406, such as any of the types of memories described above, and may further comprise mass storage 408, such as a magnetic, optical, or solid-state hard drive for example. As described above, computing resource 400 may be implemented in various forms, including general purpose computers, high performance computers, as well as combinations of elements connected via local or wide-area network connections (i.e., LANs or WANs), virtual private networks (VPNs), and so on.

Typically, memory such as memory 406 in memory resource 404 in FIG. 4, may be used to store sequences of programming instructions for causing a processor to perform certain functions required to implement a functional module, such as those in the example of FIG. 1. The different functional modules of FIG. 1 may be implemented, for example, on a single computer, high-performance computing system, and/or a local or distributed network of computing resources.

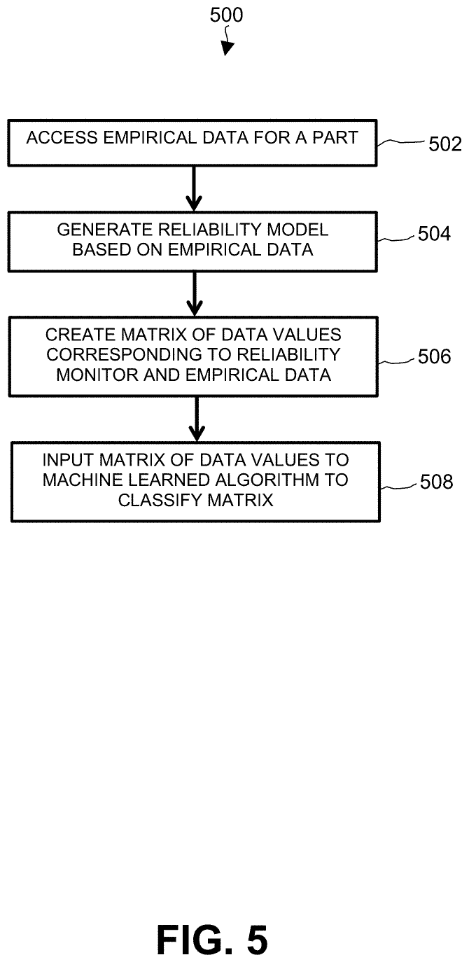

Turning to FIG. 5, there is shown a block diagram of a method 500 for classifying a reliability model for a part in accordance with one example. As shown in FIG. 5, a first block 502 is to access empirical data for a part. As described herein, the empirical data may include an identification of a manufacturer or supplier of the part, the date of manufacture, shipping or sale of a part, and any other information that may be deemed relevant to reliability analysts.

In block 504, an implementation of reliability model generating module 108 from FIG. 1 is utilized to generate a reliability model for the part based on the empirical data accessed in block 502. As described herein, in one example, the reliability model generated in block 504 may be in once example, a Weibull distribution model including upper, median, and lower confidence functions.

In block 506, a matrix of data points is generated, to include a plurality of data points representing each of the functions comprising the reliability model (e.g., upper, median, and lower confidence functions) as well as the empirical data.

In block 508, the matrix generated in block 506 is applied as input to a machine-learned algorithm module to automatically classify the model generated in block 504 into one of a predetermined plurality of classes, as described herein.

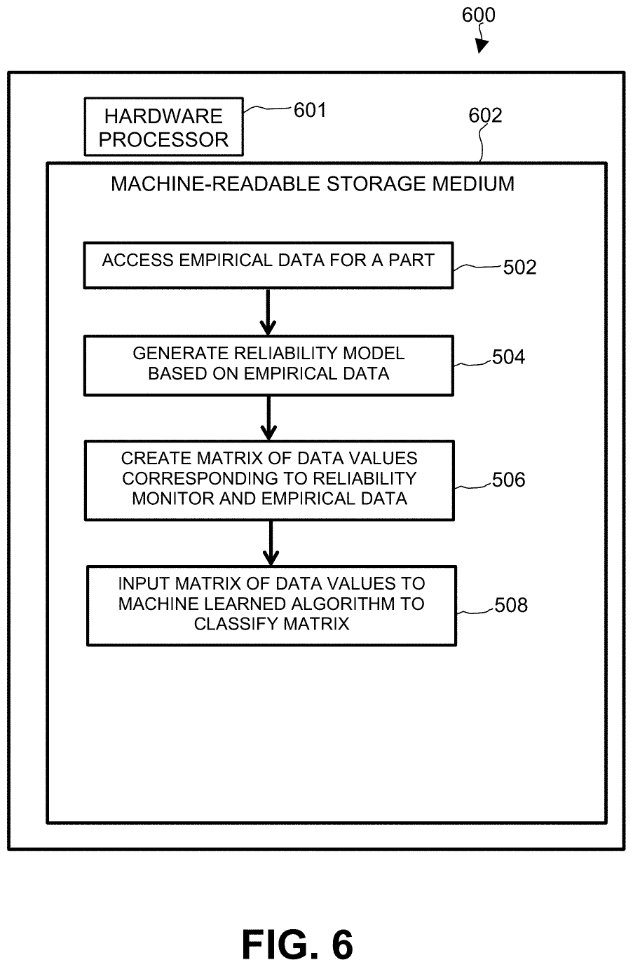

FIG. 6 is a block diagram representing a computing resource 600 implementing a method of reliability prediction and classification according to one or more disclosed examples. Computing device 600 includes at least one hardware processor 601 and a machine-readable storage medium 602. As illustrated, machine readable medium 602 may store instructions, that when executed by hardware processor 601 (either directly or via emulation/virtualization), cause hardware processor 601 to perform one or more disclosed methods of reliability prediction and classification. In this example, the instructions stored reflect a method 500 as described with reference to FIG. 5.

Certain terms have been used throughout this description and claims to refer to particular system components. As one skilled in the art will appreciate, different parties may refer to a component by different names. This document does not intend to distinguish between components that differ in name but not function. In this disclosure and claims, the terms “including” and “comprising” are used in an open-ended fashion, and thus should be interpreted to mean “including, but not limited to . . . . ” Also, the term “couple” or “couples” is intended to mean either an indirect or direct wired or wireless connection. Thus, if a first device couples to a second device, that connection may be through a direct connection or through an indirect connection via other devices and connections. The recitation “based on” is intended to mean “based at least in part on.” Therefore, if X is based on Y, X may be a function of Y and any number of other factors.

The above discussion is meant to be illustrative of the principles and various implementations of the present disclosure. Numerous variations and modifications will become apparent to those skilled in the art once the above disclosure is fully appreciated. It is intended that the following claims be interpreted to embrace all such variations and modifications.

What is claimed is:

1. A method for classifying a reliability distribution model for a part derived from empirical reliability data for the part, the method comprising:
converting, by a computing device, the reliability distribution model and the empirical reliability data into a plurality of data points in a matrix;
assigning the matrix to one of a plurality of classes by machine-learned pattern recognition in part according to an assessment of a statistical fit between the reliability distribution model and the empirical reliability data associated with the reliability distribution model; and
providing a notification to a user of the reliability distribution model indicating that further reliability analysis is to be performed on the reliability distribution model based on the one class assigned to the matrix.

2. The method of claim 1, wherein the assignment of the matrix to one of the predetermined plurality of classes is also performed in part according to a further assessment, by the machine-learned pattern recognition, of the failure rate predicted by the reliability distribution model.

3. The method of claim 1, wherein converting the reliability distribution model and the empirical reliability data into a plurality of data points in a matrix comprises converting an upper confidence function, a lower confidence function, and a median confidence function of the reliability distribution model, and the empirical reliability data, into the plurality of data points in the matrix.

4. The method of claim 1, wherein the predetermined plurality of classes comprises at least a first no-fit class corresponding to less than a minimum degree of correlation between the reliability distribution model and the empirical reliability data, a second fit-and-high-rate class corresponding to at least a minimum degree of correlation between the reliability distribution model and the empirical reliability data and a relatively high maximum predicted failure rate predicted by the reliability distribution model, a third fit-and-low-rate class corresponding to at least a minimum degree of correlation between the reliability distribution model and the empirical reliability data and a relatively low maximum predicted failure rate predicted by the reliability distribution model, and a fourth inconclusive class corresponding to an insufficient amount of empirical reliability data to assess correlation between the reliability distribution model and the empirical reliability data.

5. The method of claim 3, wherein the reliability distribution model comprises a Weibull distribution model of the empirical data.

6. The method of claim 1, wherein the machine-learned pattern recognition algorithm comprises a random decision forest algorithm.

7. The method of claim 1 further comprising: providing the notification to the user in response to a substantial lack of correlation between the reliability distribution model to the empirical data.

8. The method of claim 1 further comprising: providing the notification to the user in response to a good fit of the empirical data to the reliability distribution model, wherein the reliability distribution model that shows a relatively maximum high failure rate.

9. A computing system for classifying a reliability distribution model for a part derived from empirical reliability data for the item, comprising:
a reliability distribution model generator module, implemented by a processor executing a sequence of instructions stored in a memory, to generate a reliability distribution model based on the empirical reliability data;
a conversion module, coupled to the reliability distribution model generator module and implemented by a processor executing a sequence of instructions stored in a memory, to convert the reliability distribution model, and the empirical reliability data for the part, into a plurality of data points in a matrix;
a machine-learned algorithm module, coupled to the conversion module and implemented by a processor executing a sequence of instructions to apply a machine-learned pattern recognition algorithm to the matrix and to assign the matrix to one of a predetermined plurality of classifications;
the machine-learned algorithm module being trained to assign the matrix to one of the predetermined plurality of classes in part according to an assessment, by the machine-learned algorithm module, of the statistical fit between the reliability distribution model and the empirical reliability data on which the reliability distribution model was based.

10. The computing system of claim 9, wherein the machine-learned algorithm module assigns the matrix to one of a predetermined plurality of classes in part according to an assessment, by the machine-learned algorithm module, of the failure rate predicted by the reliability distribution model.

11. The computing system of claim 9, wherein the conversion module converts the reliability distribution model and the empirical reliability data into the plurality of data points in the matrix by converting an upper confidence function, a lower confidence function, and a median confidence function of the reliability distribution model, and the empirical reliability data, into the plurality of data points in the matrix.

12. The computing system of claim 11, wherein the reliability distribution model comprises a Weibull distribution model of the empirical data.

13. The computing system of claim 9, wherein the predetermined plurality of classes comprises at least four classes.

14. The computing system of claim 9, wherein the machine-learned algorithm module comprises a random decision forest algorithm.

15. The computing system of claim 9, wherein the empirical reliability data for the part comprises a data partition corresponding to the part and at least one variable characteristic of the part.

16. The method of claim 15, wherein the at least one variable characteristic of the item comprises a manufacturer of the item.

17. A non-transitory computer-readable medium tangibly embodying instructions executable by a hardware processor to:
convert a reliability distribution model generated from empirical reliability data for a part into a plurality of data points in a matrix;
input the matrix to a machine-learned pattern recognition algorithm trained to assign the matrix to one of a predetermined plurality of classes; and
assign the matrix to one of the predetermined plurality of classes in part according to an assessment, by the machine-learned pattern recognition algorithm, of the statistical fit between the reliability distribution model and the empirical reliability data on which the reliability distribution model was based.

18. The non-transitory computer-readable medium of claim 17, wherein the instructions further cause the processor to assign the matrix to one of the predetermined plurality of classes in part according to a further assessment, by the machine-learned pattern recognition algorithm, of the failure rate predicted by the reliability distribution model.

19. The non-transitory computer-readable medium of claim 17, wherein the reliability distribution model comprises a Weibull distribution model of the empirical data.

20. The non-transitory computer-readable medium of claim 17, wherein the machine-learned pattern recognition algorithm comprises a random decision forest algorithm.
